(19) United States
(12) Patent Application Publication
(10) Pub. No.: US 2025/0307164 A1
(43) Pub. Date: Oct. 2, 2025

(54) DECOUPLED CACHE ARCHITECTURE

(71) Applicants: Advanced Micro Devices, Inc., Santa Clara, CA (US); ATI Technologies ULC, Markham (CA)

(72) Inventors: Cian Zhang, Shanghai (CN); Akshay Lahiry, Boxborough, MA (US); Jimshed B. Mirza, Toronto (CA)

(73) Assignees: Advanced Micro Devices, Inc., Santa Clara, CA (US); ATI Technologies ULC, Markham (CA)

(21) Appl. No.: 18/621,499

(22) Filed: Mar. 29, 2024

(51) Int. Cl. G06F 12/0877

(52) U.S. Cl. CPC G06F 12/0877; G06F 2212/60

(57) ABSTRACT

A technique for operation a cache is provided. The technique includes receiving an access request for a cache that specifies an access size in sub-cache line sectors; determining which sectors for the access request are present in the cache; and accessing the cache based on the determining.

### BACKGROUND

Computer system memory is able to store a large amount of data, but has relatively high access times. Cache memories, which are smaller but faster than computer system memory, store data deemed likely to be used in the near future. Improvements to the manner in which cache memories select which data to store are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 is a block diagram of the cache, according to an example;

FIG. 5 illustrates an example of the contents of an item of way metadata;

FIG. 6 illustrates a logical view of the cache of FIG. 4, according to an example;

FIG. 7 illustrates a lookup for a memory access operation in the cache, according to an example;

FIG. 8 illustrates an example set of operations performed by the cache controller in the event of a full hit;

FIG. 9 illustrates operations performed by the cache controller in the event of a partial miss or a full miss, according to an example; and

FIG. 10 is a flow diagram of a method for accessing a cache having ways divided into sectors, according to an example.

### DETAILED DESCRIPTION

A technique for operation a cache is provided. The technique includes receiving an access request for a cache that specifies an access size in sub-cache line sectors; determining which sectors for the access request are present in the cache; and accessing the cache based on the determining.

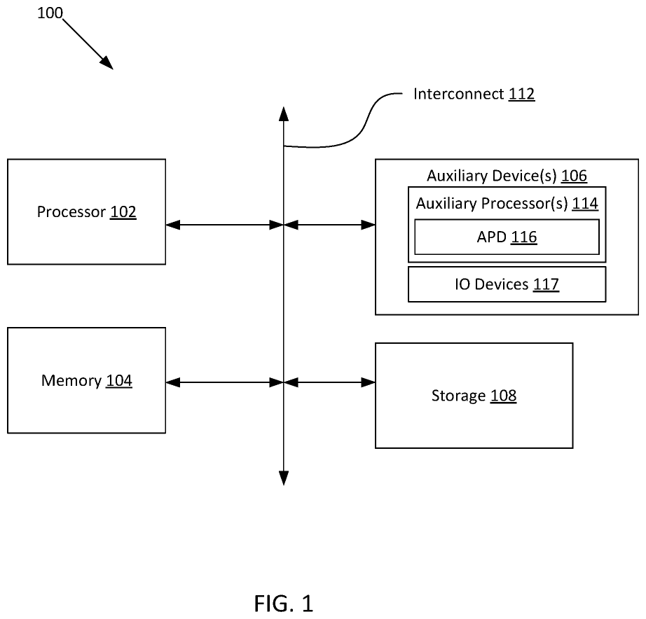

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

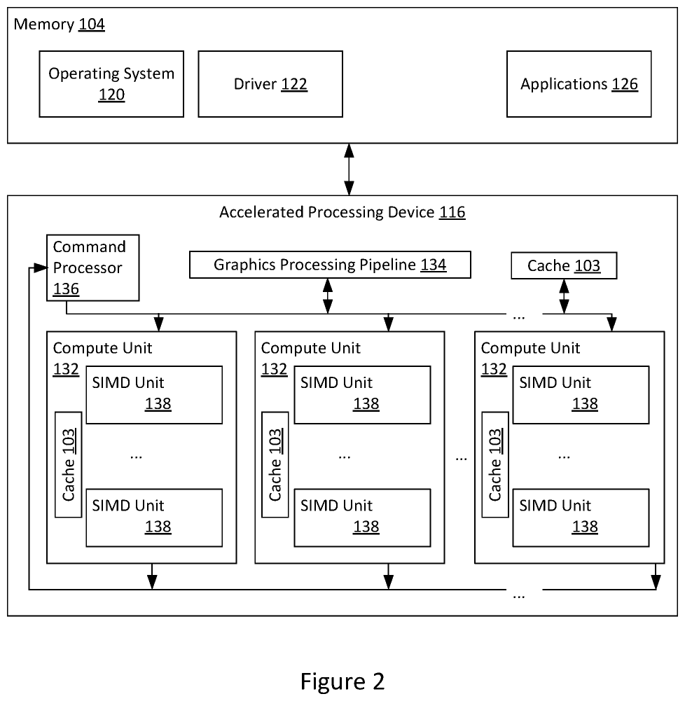

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

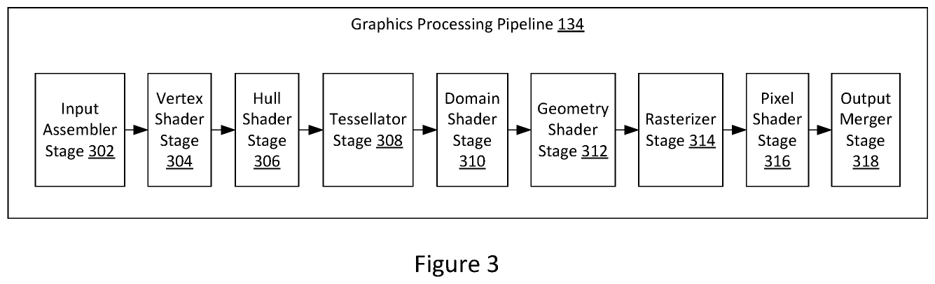

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

One or more portions of the graphics processing pipeline 134 utilizes a form of color compression referred to as delta color compression. As with any compression, with delta color compression, raw data is stored in a compressed format that consumes less space in memory than with the raw data. With delta color compression, raw data for a color is compressed into a delta color compressed form. The raw data for the color includes a color component value for each of a set of color components (e.g., red, green, and blue) that comprise the color. Each color component value includes a “full” number of bits, such as 8. In the delta color compressed format, data for a collection of two or more colors is stored as an uncompressed base color and a set of delta values. Each delta value corresponds to one of the colors. For any given color value, in the delta color compressed format, each color component of a color value is stored as a difference between the color component of the color value in the raw data and the same color component in the base value. In an example, if the value for the red color component is 10 in the base color and the value for the red color component in the color value being compressed is 12, then the red color component in the delta color compressed version of the color value being compressed is stored as 2. Often, especially where colors of a collection of two or more colors are clustered close together in the color space, storing differences in this manner provides savings in terms of the amount of data consumed. This is because a small range of values can be stored using fewer bits than a large range of values. For example, it is possible to express 4 different values using 2 bits, 8 different values using 3 bits, 16 different values using 4 bits, and so on. If the color components of a collection of colors fall within 16 of the base color, then 4 bits, rather than a large number (e.g., 8) can be used for each delta color component. If the colors are all the same, then an even smaller number of bits can be used.

One aspect of delta color compression is that the amount of data occupied by a fixed number of color values of a collection of color values is variable, based on the variations of colors. For color values that are close together, a smaller amount of data can be used for a collection of color values as compared with color values that are more diverse. This means that, if a fixed amount of an address space is reserved for each collection of colors, then care must be taken to help reduce or eliminate the amount of space that is wasted in a memory such as a cache.

In FIG. 2, the APD 116 is illustrated as including one or more caches 103. In various examples, a shared cache 103 that is shared between the compute units 132, and or a cache 103 is included in each compute unit 132. Although these example cache locations are shown, various implementations include one or more caches 103 at one or more other technically feasible locations.

In operation, in some examples, the APD 116 generates color values and stores compressed versions of such color values in one or more such caches 103. In some examples, the graphics processing pipeline 134 generates such values. In an example, the pipeline generates such values and writes such values to a frame buffer using the output merger stage 318. In some examples, the cache 103 (e.g., a controller within the cache 103) compresses raw values generated by the graphics processing pipeline 134 into delta color compressed values and stores the compressed values into the cache 103. In some examples, the graphics processing pipeline 134 also reads values from the cache 103, and the cache 103 decompresses the stored compressed values and provides the reconstructed raw data to the graphics processing pipeline 134. In other examples, the graphics processing pipeline 134 or another entity performs the compression and decompression for data written to and read from the cache by the graphics processing pipeline 134 or another entity.

It is efficient to compress collections of colors together, where each collection of colors is guaranteed to fit within one cache line. Again, a “collection of colors” is a set of colors compressed together, such as a set that includes one base color and one or more delta colors as described elsewhere herein. In some instances, the compressed version of the collection of colors is referred to herein as a compression unit. In some examples, a cache line is a collection of data that is mapped to a single way in a set-associative cache. Often, cache lines are considered the basic unit of data addressable in a cache. Having a one-to-one correspondence between cache lines and compression units allows the cache controller (or other entity that performs compression and/or decompression) to fetch and compress or decompress whole cache lines in a unitary operation. Although having such a one-to-one correspondence is useful, it can waste a lot of space in the cache, since a collection of delta color compressed values has a variable size and can thus be either equal to the size of a cache line or much smaller than a cache line (or any amount in between). Thus, techniques are provided herein to have cache lines consume a variable amount of space within a cache. It should be understood that although the use case of delta color compression is described herein, the disclosure herein is not limited to the use case of delta color compression and can be used for any technically feasible situation.

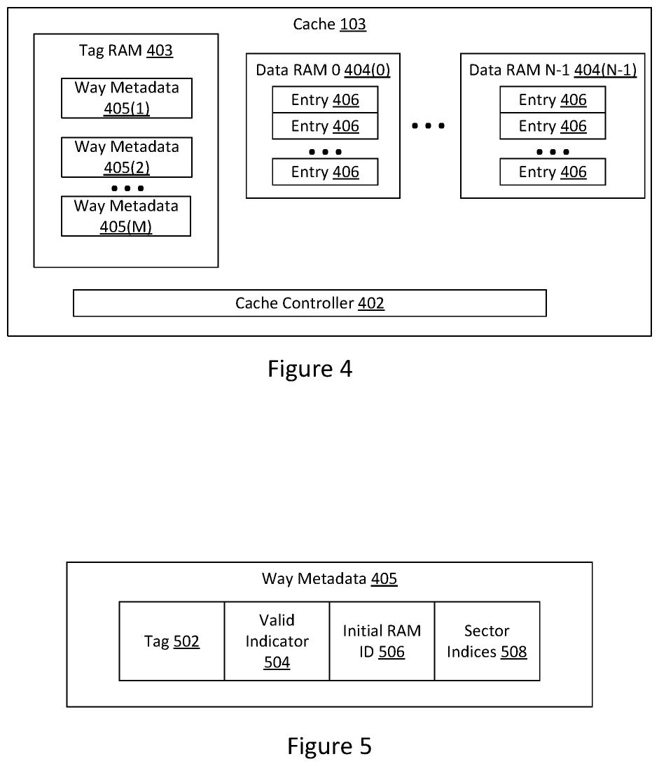

FIG. 4 is a block diagram of the cache 103, according to an example. The cache includes a cache controller 402, a tag RAM 403, and a plurality of data random access memories 404 (“RAMs”). The tag RAM 403 stores a plurality of way metadata items 405, and each data RAM 404 includes a plurality of entries 406. The cache controller 402 is one or more of hardware (e.g., circuitry, such as a programmable or fixed function processor, a field programmable gate array, a programmable logic device, an application specific integrated circuit, or any other technically feasible circuitry), software executing on a processor, or a combination of hardware and software.

Each way metadata item 405 stores metadata for a “way” for the cache 103. More specifically, the cache 103 is a set associative cache in which any particular address is mapped to a single set which includes multiple ways. Any particular cache line can map to a plurality of ways, reducing contention within a particular set. Each set/way combination is capable of storing a single cache line, and if that cache line includes multiple sectors, that cache line is distributed across multiple RAMs 404. Each way metadata entry 405 includes metadata for a single way of the cache 103.

Cache lines in the cache 103 are divided into a plurality of sectors. Each entry 406 in the data RAMs 404 is configured to store one sector of one way. In some examples, a cache line can consume up to N (the number of RAMs 404) sectors, though it is also possible for a cache line to consume more than N sectors. In some examples, for any given cache line, the cache controller 402 stores each sector of the cache line in an entry 406 of a different RAM 404, such that each sector of a cache line is stored in a different RAM 404.

In general, when the cache controller 402 receives an access request (e.g., a request to read or write data at a particular address), the cache controller 402 maps the request to a way, fetches any missing sectors into one or more appropriate entries 406, and accesses all entries 406 for the cache line according to the request. The cache controller 402 maintains way metadata 405 that tracks where (e.g., in which RAM 404 and which entry 406) the sectors are stored, as well as which sectors of any given cache line are resident in the cache (as it is possible for some, but not all sectors of a cache line to be present in the cache).

FIG. 5 illustrates an example of the contents of an item of way metadata 405. Each item of way metadata 405 stores metadata for a corresponding way. The item of way metadata 405 includes a tag 502, a valid indicator 504, an initial RAM ID 506, and sector indices 508. The tag 502 is a value that facilitates determining whether a cache line for a request is resident in the cache 103. More specifically, an address for a request includes a set portion (a subset of the bits of the address) that selects a set, as well as a tag portion. When the cache controller 402 determines which set an address maps to, the cache controller 402 determines whether there is any valid way in that set whose tag 502 matches the tag portion of the request address. If there is no such way, then a miss occurs and if there is such a way, then a hit occurs. The valid indicator 504 indicates which sectors for the way are valid in the cache 103. In some examples, in the case that all bits of the valid indicator 504 are 0 (indicating that all sectors for the way are invalid), this is an indication that the entire way is invalid. Since each way includes multiple sectors, but does not need to include the maximum number of sectors, it is possible that any given way has fewer than the maximum number of sectors in the cache 103. It is also possible for a way to be partially evicted, as described elsewhere herein, and this partial eviction, combined with the variable size of ways, are reasons why a way can have fewer than the maximum number of sectors resident in the cache 103. In some examples, the valid indicator 504 indicates, for each sector of a way, whether that sector is valid in the cache 103.

The initial RAM ID 506 indicates the data RAMs 404 that each sector of the corresponding way is located in. In some implementations, the initial RAM ID 506 indicates the data RAM 404 in which the “first” sector of the corresponding way is stored (or is assigned to, as that sector may not actually be stored in the cache 103). In some examples, sectors of a way are numbered from 0 to N−1 and the 0^{th} sector is the “first” sector. In some examples, the indication of the data RAM 404 in which the first sector of a way is stored also indicates which data RAM 404 each other sector of that way is stored. More specifically, in some examples, the first sector is stored in the data RAM 404 whose ID number is the initial RAM ID 506. The second sector is stored in the data RAM 404 whose ID number is one higher than the initial RAM ID 506, with a numerical wrap. A numerical wrap means that when the number is greater than the number of the last data RAM 404, that number instead becomes the number of the first data RAM 404. For example, if the initial RAM ID 506 for a way is equal to N−1, and the data RAM ID numbers go from 0 to N−1, then the second sector for the way is stored in data RAM 0 404(0), since N is greater than the highest data RAM ID of N−1. The third sector would be stored in data RAM 1 404(1), and so on. It should be understood that the data RAM identifier (“ID”) number is the number that uniquely identifies a particular data RAM 404. Although a mechanism is described in which the initial RAM ID 506 identifies the first data RAM 404 that corresponds to the 0^{th} sector of a way, alternative implementations are contemplated. In general, in such alternative implementations the initial RAM ID 506 (which may be referred to simply as “RAM ID mapping information” in such implementations) indicates which data RAMs 404 each sector of the corresponding way is stored in.

The sector indices 508 indicate which entry 406 of an appropriate data RAM 404 stores the sector for the corresponding way. Each entry 406 in each data RAM 404 has an index that uniquely identifies that entry 406. A combination of data RAM ID and index thus uniquely identifies a particular entry 406 in a particular RAM 404. In some examples, the sector indices 508 includes an index for each valid sector in the corresponding way. In an example, for sector 0, the sector indices 508 includes index 5, for sector 1, the sector indices 508 includes index 2, for sector 2, the sector indices 508 includes index 5, and so on. In an example, if the initial RAM ID 506 is 0, then sector 0 is stored in RAM 0 404(0), entry 5, sector 1 is stored in RAM 1 404(1), entry 2, sector 2 is stored in RAM 2 404(2), entry 5, and so on.

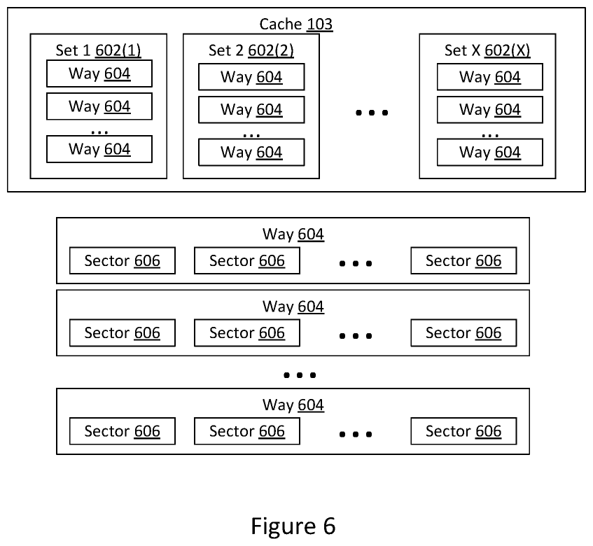

FIG. 6 illustrates a logical view of the cache 103, according to an example. The cache 103 includes a plurality of sets 602, each of which includes a plurality of ways 604. Each way 604 includes a plurality of sectors 606, as shown.

As stated elsewhere herein, any given request to access the cache 103 (e.g., a read request or a write request) includes an address that has a set portion and a tag portion. The set portion identifies one of the sets 602 and the tag portion acts to match the request to one of the ways 604 in the mapped set 602. The request also includes a size that indicates a number of sectors for the request. This size indicates how many of the sectors 606 in a way are involved in the request. In an example, if a cache line is 128 bytes and there are four sectors 606 in each way, then if the size indicates 64 bytes, then the request is for two sectors 606.

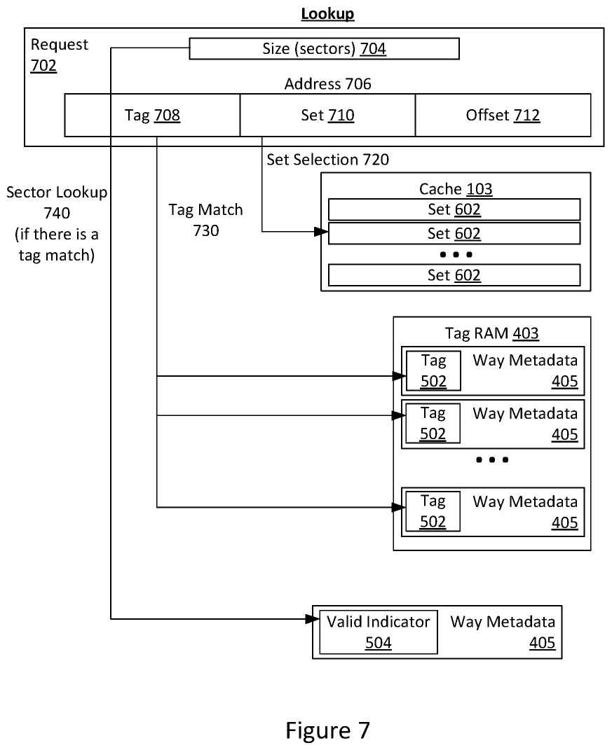

FIG. 7 illustrates a lookup for a memory access operation in the cache, according to an example. The cache controller 402 receives a request 702 that specifies a size 704 in sectors, as well as an address. The request 702 is request to read or write to data at the address 706, and the amount of data to be read or written is specified by the size 704. In an example, a “client” of the cache 103 (e.g., the processor 102, a processor in the APD 116, or another entity that provides a request 702 to the cache 103) determines that a particular amount of data is to be read from or written to the cache (e.g., based on an instruction executed by that client) and specifies that amount of data in the size 704 portion of the request. The address 706 includes a tag portion 708, a set portion 710, and an offset 712. The set portion 710 selects a set 602 for the request 702 and the tag portion 708 is used to match the request to a way 604 of the selected set 602. The offset is a value that is generally (though not necessarily) not used by the cache 103 but references specific data within a cache line.

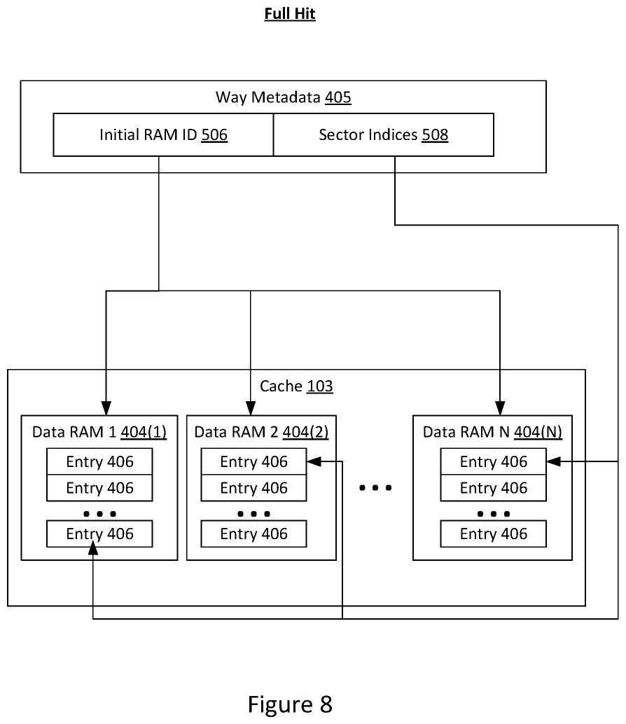

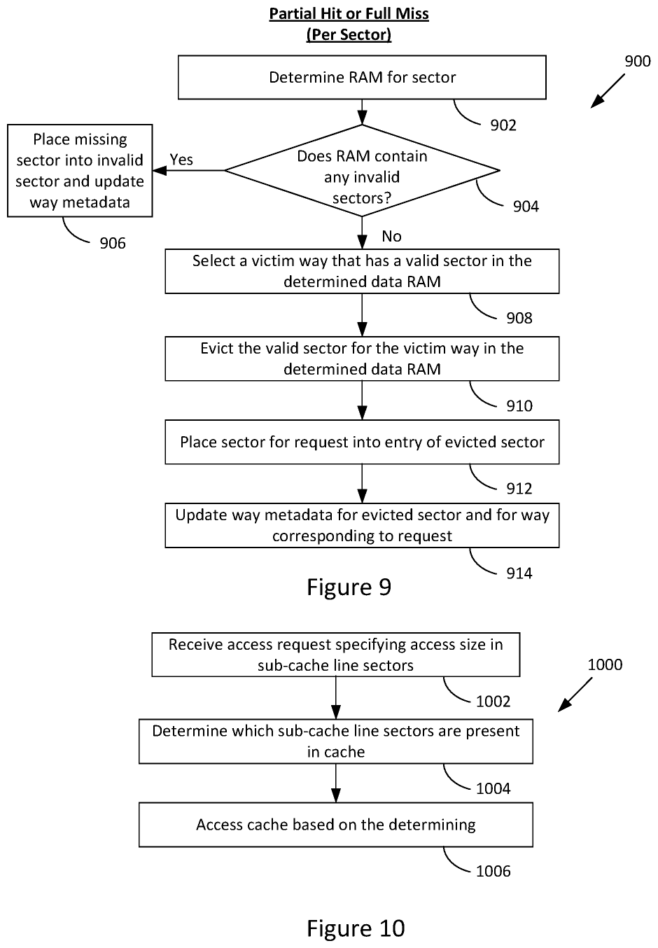

To perform the lookup, the cache controller 402 does the following. The cache controller uses the set portion 710 to select a set 602 in set selection 720. In tag match 730, the cache controller 402 attempts to match the tag 708 of the address with the tag 502 of the way metadata 405 for each way 604 of the selected set 602. If there is no tag 502 that matches the tag 708 of the request 702, then a full miss occurs. If there is a tag 502 that matches the tag 708 of the request 702, then the cache controller 402 performs sector lookup 740 to determine which sectors of the request are in the cache 103. Sector lookup 740 involves the cache controller 402 checking the valid indicator 504 of the way metadata 405 for the way whose tag 502 matched the tag 708 of the request to determine which sectors 606 are in the cache 103. As stated elsewhere herein, the valid indicator 504 indicates which sectors 606 of a way 604 are resident. If all of the requested sectors 606 are present, then there is a full hit and if some but not all of the requested sectors 606 are present, then there is a partial hit (also sometimes referred to as a “partial miss”). If there is no tag 502 that matches the tag 708 of the request 702, then a full miss occurs. FIGS. 8 and 9, described below, discuss a full hit (FIG. 8) and a partial hit or full miss (FIG. 9).

FIG. 8 illustrates an example set of operations performed by the cache controller 402 in the event of a full hit. In the event of a full hit, the cache controller 402 utilizes the initial RAM ID 506 and the sector indices 508 to access the appropriate entries 406 of the data RAMs 404. As described elsewhere herein, the initial RAM ID 506 identifies which data RAM 404 the first sector of the way is stored in, with subsequent sectors of the way being stored in subsequently numbered data RAMs 404, along with a numerical wrap.

The cache controller 402 performs the operation of the request (e.g., a read or a write), using the identified entries 406 for each sector of the request. In an example, the request is a read request and the cache controller 402 thus reads the data of the appropriate entry or entries 406 and returns that data to the client of the cache 103 that sent the request. In another example, the request is a write request and the cache controller 402 thus writes data specified by the request to the entries 406 associated with the request. In some examples, the request specifies which sectors of a way are involved, and, for writes, which data is to be stored in which sector. In such examples, the cache controller 402 reads or writes the entries 406 specified according to this information.

FIG. 9 illustrates operations performed by the cache controller 402 in the event of a partial miss or a full miss, according to an example. In either a partial miss or a full miss, some or all of the sectors 606 of a request are missing in the cache 103. To service the miss, the cache controller obtains the data for each sector and places each such data into an appropriate entry 406. An example method 900 for servicing a miss for a particular sector is illustrated in FIG. 9.

At step 902, the cache controller 402 determines the data RAM 404 for the sector 606. The data RAM 404 for any given sector 606 is based on the initial RAM ID 506 and the identity of the sector 606. As described elsewhere herein, the initial RAM ID 506 indicates which data RAM 404 is assigned to each sector 606 of a way 604, with different data RAMs 404 being assigned to different sectors 606 of the same way. It should be noted that even where one or more sectors 606 of a way are absent from the cache 103, any given sector 606 of a way is assigned to a particular data RAM 404 by the initial RAM ID 506. Where a partial miss occurs, there is already a way metadata entry 405 for the way. Thus, the cache controller 402 determines, for each of the sectors 606 of the request that are not present in the cache 103, which data RAM 404 is assigned to that sector 606. Again, in some examples, the initial RAM ID 506 indicates the data RAM 404 that is assigned to the first sector 606 of the way 604. For the numerically subsequent sector 606, the RAM ID 506 is equal to the RAM ID 506 of the first sector 606, plus one, with numerical wrap. Each subsequent sector 606 is assigned a numerically subsequent RAM ID 506, with wrap, in a similar manner.

At step 904, the cache controller 402 determines whether the data RAM 404 contains any invalid entries 406. An invalid entry 406 is an entry that no way metadata 405 indicates is valid. If the data RAM 404 contains at least one invalid entry 406, then the method 900 proceeds to step 906 and if the data RAM 404 does not contain at least one invalid sector, then the method 900 proceeds to step 908. At step 906, the cache controller 402 places the sector into an invalid entry 406 of the assigned data RAM 404 and updates the way metadata 405 for the way to indicate that the sector now in the data RAM 404 is valid and to indicate which entry 406 that sector is stored in.

At step 908, the cache controller 402 has determined that there are no invalid entries 406 in the assigned data RAM 404. In this situation, the cache controller 402 selects an entry 406 for eviction. Cache controllers 402 implement an eviction policy to determine which way to evict in the event that eviction is needed. Specifically, the cache controller 402 selects a way based on an eviction policy. In the system of the present disclosure, eviction of a way involves both considering whether a way meets the criteria of the eviction policy, as well as whether such a way actually includes a valid sector 606 in the data RAM 404 assigned to the sector 606 to be placed into the cache by the method 900.

In an example, a least-recently-used policy is used. In this policy, the cache controller 402 maintains an access recency counter that is reset to 0 when a way 604 is accessed (e.g., read from or written to, including when newly allocated into the cache 103) and that counts up when an aging event (such as an access that targets a different way in the same set 602) occurs. In general, in this policy, the cache controller 402 selects the oldest way 604 for eviction. However, it is possible for the way 604 with the oldest counter to not have any sectors 606 in the data RAM 404 assigned to the sector to be placed into the cache by the method 900. Thus, the cache controller 402 selects a different way 604, such as the way with the oldest (e.g., highest) counter that also has a valid sector in that data RAM 404, so that such sector 606 can actually be evicted.

At step 910, the cache controller 402 evicts the valid sector 606 for the victim way in the determined data RAM 404. Eviction occurs in any technically feasible manner. In some examples, if the sector is “dirty” (has been written to after being brought into the cache 103), then eviction includes writing the data of that sector out to a backing memory such as a higher level cache or memory. If the sector is not dirty, then no such write occurs. Although some operations for eviction are described, the cache 103 is not limited to such operations and can perform any other technically feasible operations for eviction. At step 912, the cache controller 402 places the sector that the method 900 is placing into the cache 103 into the entry 406 of the evicted sector. In various examples, this step involves storing the data of that sector into the entry 406. At step 914, the cache controller 103 updates the way metadata 405 for both the way 604 whose sector 606 was evicted, as well as the way metadata 405 for the way 604 whose sector was placed into the cache 103 (replacing the evicted sector 606). For the evicted sector 606, the cache controller 103 updates the valid indicator 504 to indicate that the evicted sector 606 is not valid and for the newly placed sector 606, and the cache controller 103 updates the valid indicator 504 to indicate that the newly placed sector 606 is valid. It should be understood that for each sector 606 evicted, the cache controller 103 updates the way metadata 405 for that sector 606. For any given request, it is possible to evict multiple sectors 606, so a request may result in updating of way metadata 405 for multiple evicted sectors 606 of different ways.

It should be noted that the way 604 for the evicted sector may still have other valid sectors 606 in the cache 103, or that the evicted sector 606 may be the last sector for a way 604 remaining in the cache, in which case the entire way 604 would be invalid.

In addition, if the sector 606 being placed into the cache by the method 900 is for a cache line that is not already in the cache, then the cache controller 402 assigns that sector 606 to a way 604 of the cache 103. In some implementations, the cache controller 402 selects the oldest way 604 of the sectors evicted for the cache line at step 910. In other words, if a cache line being brought into the cache 103 has no sectors already in the cache, then the cache controller 402 performs the method 900 for each sector of that cache line being brought into the cache 103. Since it is possible for the evicted sectors 606 to be from different ways 604, and all sectors of a cache line are in a single way, the cache controller 402 selects the oldest way 604 of the sectors evicted for the cache line at step 910. For example, if the cache line being brought in includes a 0^{th} sector and a 1^{st} sector, and step 910 determines that the 0^{th} sector is to be placed into way 4 and the 1^{st} sector is to be placed into way 6, and way 6 is older than way 4, then the cache controller 402 assigns way 6 to the cache line and all sectors 606 of that cache line.

In addition to the above, again, it is possible for a cache line to be brought in either partially (e.g., a partial miss, where some but not all of the requested sectors are already in the cache) or fully (e.g., a full miss, there is no tag match). In the event of a partial miss, the cache controller 402 does not assign an initial RAM ID 506 to that cache line, as that information is already in the cache for the already-present sectors. In the event of a full miss, the cache controller 402 assigns an initial RAM ID 506 to that cache line. In some examples, the cache controller 402 tracks the number of each possible initial RAM ID 506 value within a set and selects the initial RAM ID 506 whose number of values in the set is the lowest (with any technically feasible tie breaker, such as selecting the lowest initial RAM ID 506 value or in any other way). In an example, a set 602 includes four data RAMs 404. Further, in that set, there are 5 ways 604 whose initial RAM ID 506 is 0, 3 ways 604 whose initial RAM ID 506 is 1 and 2, and 2 ways 604 whose initial RAM ID 506 is 3. In this example, the cache controller 402 selects, for a new cache line to be entered into the cache, an initial RAM ID 506 of 3, as that number has the lowest number of instances in the set 602. In another example, the cache controller 402 selects the initial RAM ID 506 that has the lowest number of valid entries 406. In other words, if a particular RAM 404 has more invalid entries than any other RAM 404, then the cache controller 402 selects that particular RAM 404 as the initial RAM ID 506 for the newly brought-in cache line. Stated again, a full miss occurs where there is no tag match. In this instance, a new way is allocated. A full hit occurs where there is a tag match—in this situation, no new way is allocated. A partial hit occurs where a tag match occurs but at least some sector is not resident in the cache. In this example, a new way is not allocated.

An example operation is illustrated with respect to the following tables:

TABLE 1
Valid indicators and LRU data before a first operation

| | Way0 | Way1 | Way2 | Way3 | Way4 | Way5 | Way6 | Way7 |
|---|---|---|---|---|---|---|---|---|
| LRU ctr | 7 | 3 | 5 | 6 | 4 | 2 | 1 | 0 |
| Sector0 | Invalid | Valid | Invalid | Invalid | Valid | Invalid | Invalid | Valid |
| Sector1 | Invalid | Invalid | Valid | Valid | Valid | Invalid | Valid | Valid |
| Sector2 | Valid | Invalid | Valid | Invalid | Invalid | Valid | Valid | Valid |
| Sector3 | Valid | Invalid | Invalid | Invalid | Invalid | Valid | Valid | Valid |

TABLE 2
Valid indicators and LRU data after a first operation

| | Way0 | Way1 | Way2 | Way3 | Way4 | Way5 | Way6 | Way7 |
|---|---|---|---|---|---|---|---|---|
| LRU ctr | 0 | 4 | 6 | 7 | 5 | 3 | 2 | 1 |
| Sector0 | Valid | Valid | Invalid | Invalid | Invalid | Invalid | Invalid | Valid |
| Sector1 | Valid | Invalid | Valid | Invalid | Valid | Invalid | Valid | Valid |
| Sector2 | Valid | Invalid | Valid | Invalid | Invalid | Valid | Valid | Valid |
| Sector3 | Valid | Invalid | Invalid | Invalid | Invalid | Valid | Valid | Valid |

In the above operation, additional data for an already existing cache line is brought into the cache. In other words, a request targeting a specific cache line that is already partially resident in the cache occurs. The cache line that is already partially resident is in way 0. As can be seen in table 1, the first two sectors are invalid for way 0. Thus, the cache controller 402 evicts the oldest valid sector 0 and sector 1. In the example, way 4 stores the oldest valid sector 0 (LRU ctr—“least recently used counter” being 4 and thus older than any other sector 0) and way 3 stores the oldest valid sector 1 (with LRU counter value of 6). After this eviction, the cache controller 402 reclaims the entries 406 of such evicted sectors for use for the cache line of way 0. Way 0 now has all four sectors valid, and the LRU values are updated for all ways as shown.

FIG. 10 is a flow diagram of a method 1000 for accessing a cache 103 having ways 604 divided into sectors 606, according to an example. Although described with respect to the system of FIGS. 1-9, those of skill in the art will understand that any system configured to perform the steps of the method 1000 in any technically feasible order, falls within the scope of the present disclosure.

At step 1002, the cache controller 402 receives an access request 702. The access request 702 specifies a size in sectors 704 and an address 706. The size 704 and address 706 are described in further detail elsewhere herein, such as with respect to FIG. 7. The cache controller 402 receives the access request 702 from a client such as any processor (e.g., processor 102, APD 116, or any other processor), or any other hardware or software elements of a computing device (such as device 100). In some examples, an instruction executing on a processor executes a memory access instruction such as a load or store instruction, and this request specifies the address targeted by the instruction. In response, the processor generates the request 702 and transmits the request 702 to the cache 103 to be performed. The cache 103 services the request, fetching into the cache any data for the request that is not already in the cache 103, and accessing that data as per the request (e.g., reading or writing that data in the cache).

At step 1004, the cache controller 402 determines which sub-cache line sectors 606 are present in the cache 103. A lookup operation for performing this activity is described with respect to FIG. 7. In general, this lookup operation includes identifying a set 602 based on a set portion 710 of the address 706, and attempting to match the tag portion 708 of the address 706 to a tag 502 of a way metadata 405 for the ways 604 of the identified set 602. If there is no match, then a full miss occurs. If there is a tag match, then the cache controller 402 determines which sectors 606 of the cache line specified by the request 702 are stored in the cache 103. This determination is performed based on the size 704 in sectors specified by the request 702 as well as the valid indicator 504 of the way metadata 405 of the way 604 for which the tag match occurs. More specifically, the valid indicator 504 indicates which sectors 606 of a way 604 are stored in the cache 103. Thus, the cache controller 402 is able to compare the size in sectors 704, which specifies which sectors of a cache line are requested by the request 702, with the valid indicator 504 to determine which sectors 606 of the request are in the cache 103.

At step 1006, the cache controller 402 performs the access in accordance with which sectors 606 are in the cache. If all sectors 606 of the request are present, then the cache controller 402 accesses each of these sectors 606. As described elsewhere herein (e.g., FIG. 8), the cache controller 402 uses the way metadata 405 of the way whose tag 502 matched the tag 708 of the request 702 to identify the entries 406 in which the sectors for the request 702 are stored. The initial RAM ID 506 identifies the data RAM 404 that stores sector 0, as well as which data RAM 404 stores each other sector 606 of the request. The sector indices 508 indicate, for each sector 606 of the way 604 stored in the cache, which entry 406 that sector 606 is stored in. Thus, the cache controller 402 access (e.g., reads or writes) the sectors 606 for the request 702 in accordance with the combination of initial RAM ID 506 and sector indices 508.

If not all of the sectors are present in the cache, then the cache controller 402 performs the operations described with respect to FIG. 9, for each missing sector. If at least one sector is already in the cache, then the cache controller 402 places the remaining sectors into the cache 103 in the same way 604 that the already-present sectors 606 are in, placing the new sectors into the data RAMs 404 specified by the initial RAM ID 506 of the way metadata 405 for that way 604. If no sectors are in the cache, then the cache controller 402 selects a way 604 for the request, chooses an initial RAM ID 506 for the way 604, places the sectors for the request in the appropriate entries 406 as specified by the initial RAM ID 506, and updates the way metadata 405 information for that way 604. Additional details about these operations are provided above, such as with respect to FIG. 9. With all sectors 606 in the cache 103, the cache controller 402 accesses these sectors in a similar manner as with respect to when a full hit occurs (FIG. 8).

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, output merger stage 318, and cache controller 402 are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method comprising:
storing a variably-sized cache line into a cache, wherein a size of the variably-sized cache line is in sub-cache line sectors;
receiving an access request for a cache that specifies an access size for the variably-sized cache line in sub-cache line sectors; and
accessing the cache based on which sectors for the access request are present in the cache.

2. The method of claim 1, wherein the access request further specifies an address that has a tag portion and a set portion.

3. The method of claim 2, wherein accessing the cache based on which sectors for the access request are present in the cache comprises performing a tag matching operation.

4. The method of claim 3, wherein the tag matching operation indicates that a way corresponding to the access request is in the cache, and accessing the cache based on which sectors for the access request are present in the cache comprises comparing a valid indicator for the way to the access size.

5. The method of claim 4, wherein the comparing of the valid indicator to the access size includes determining that all requested sub-cache line sectors are present in the cache, and the accessing includes accessing the requested sub-cache line sectors in accordance with the access request.

6. The method of claim 4, wherein the comparing of the valid indicator to the access size includes determining that not all requested sub-cache line sectors are present in the cache, and the accessing includes fetching missing sub-cache line sectors into the cache.

7. The method of claim 6, wherein the fetching includes identifying a data RAM and an entry for each missing sub-cache line sector, and placing the missing sub-cache line sectors into the identified data RAM and the entry.

8. The method of claim 6, wherein accessing further includes determining that no requested sub-cache line sector is present in the cache, and generating new way metadata for the access request.

9. The method of claim 6, wherein the fetching includes evicting one or more sectors from the cache.

10. A cache comprising:
a cache memory; and
a cache controller configured to:
store a variably-sized cache line into a cache, wherein a size of the variably-sized cache line is in sub-cache line sectors;
receive an access request that specifies an access size for the variably-sized cache line in sub-cache line sectors; and
access the cache memory based on which sectors for the access request are present in the cache memory.

11. The cache of claim 10, wherein the access request further specifies an address that has a tag portion and a set portion.

12. The cache of claim 11, wherein accessing the cache based on which sectors for the access request are present in the cache comprises performing a tag matching operation.

13. The cache of claim 12, wherein the tag matching operation indicates that a way corresponding to the access request is in the cache memory, and accessing the cache based on which sectors for the access request are present in the cache comprises comparing a valid indicator for the way to the access size.

14. The cache of claim 13, wherein the comparing of the valid indicator to the access size includes determining that all requested sub-cache line sectors are present in the cache memory, and the accessing includes accessing the requested sub-cache line sectors in accordance with the access request.

15. The cache of claim 13, wherein the comparing of the valid indicator to the access size includes determining that not all requested sub-cache line sectors are present in the cache memory, and the accessing includes fetching missing sub-cache line sectors into the cache memory.

16. The cache of claim 15, wherein the fetching includes identifying a data RAM of the cache memory and an entry for each missing sub-cache line sector, and placing the missing sub-cache line sectors into the identified data RAM and the entry.

17. The cache of claim 15, wherein accessing the cache based on which sectors for the access request are present in the cache includes determining that no requested sub-cache line sector is present in the cache memory, and generating new way metadata for the access request.

18. The cache of claim 15, wherein the fetching includes evicting one or more sectors from the cache memory.

19. A non-transitory computer-readable medium storing instructions that, when executed by a processor, causes the processor to perform operations comprising:
storing a variably-sized cache line into a cache, wherein a size of the variably-sized cache line is in sub-cache line sectors;
receiving an access request for a cache that specifies an access size for the variably-sized cache line in sub-cache line sectors; and
accessing the cache based on which sectors for the access request are present in the cache.

20. The non-transitory computer-readable medium of claim 19, wherein the access request further specifies an address that has a tag portion and a set portion.
